(19) United States
(12) Patent Application Publication
(10) Pub. No.: US 2019/0004479 A1
(43) Pub. Date: Jan. 3, 2019

(54) TIMEPIECE MOVEMENT

(71) Applicant: PARMIGIANI FLEURIER S.A., Fleurier (CH)

(72) Inventor: Béranger REYNARD, Grand Combe Chateleu (CH)

(21) Appl. No.: 16/060,578

(22) PCT Filed: Dec. 7, 2016
(86) PCT No.: PCT/IB2016/057410

§ 371 Date: Jun. 8, 2018

(30) Foreign Application Priority Data
Dec. 10, 2015 (CH) CH01809/15

(51) Int. Cl. G04B 31/008

(52) U.S. Cl. CPC G04B 31/0087

(57) ABSTRACT

A timepiece movement includes two timepiece components rotating about a common axis, namely a first timepiece component attached to an arbor including a pivot (1) at least at one of its extremities and a second timepiece component including a bearing (2) receiving said pivot (1). The pivot (1) and the bearing (2) have the form of a rounded regular polygon, preferably a rounded equilateral triangle, respectively male or female, arranged in such a manner that the pivot (1) engages in the bearing (2) with an angular clearance permitting rotation of the arbor to be transmitted to the second component by a self-locking effect.

The present invention relates to a timepiece movement including two components rotating about a common axis.

In timepiece movements, as a general rule, each part used includes an arbor equipped at its two extremities with pivots, each engaged in a bearing. The pivoting means formed from a bearing and a pivot are conventionally used to ensure the axial and radial positioning of the rotating parts that are present in the movements.

FR1033071 proposes a jewel exhibiting a hole of circular section and a pivot made from steel, exhibiting a cross section of polygonal form at its surface facing the jewel, such as to reduce the contact surfaces between the pivot and the jewel.

WO2009115519 describes a pivoting means intended to permit the rotation of a part of a timepiece movement about an axis of rotation, comprising a pivot and a bearing receiving said pivot. The contact surfaces of the two elements against one another are made from a material having a low coefficient of friction and a low rate of wear.

The aim of the present invention is to propose another arrangement for coupling two timepiece components in a coaxial manner by means of pivoting means that are easily manufactured and easily machinable.

The present invention also makes it possible to avoid strain hardening of the material caused by contact between a pivot and a bearing.

According to the invention, a timepiece movement includes two timepiece components rotating about a common axis, namely a first timepiece component attached to an arbor including a pivot at least at one of its extremities and a second timepiece component including a bearing receiving said pivot. The pivot and the bearing have the form of a rounded regular polygon with three to six sides, preferably a rounded equilateral triangle, respectively male or female, arranged in such a manner that the pivot engages in the bearing with an angular clearance permitting rotation of the arbor to be transmitted to the second component by a self-locking effect.

In one embodiment, the rounded triangular form of the pivot and the bearing exhibits respectively a diameter D1, D1′ of a virtual inscribed circle tangent to the three sides of the triangle and respectively a diameter D2, D2′ of a virtual circumscribed circle passing through the three vertices, where the relationship D1/D2 or D1′/D2′ lies between 0.5 and 0.95.

According to this same embodiment, the rounded triangular form of the bearing exhibits a diameter D2′ of a virtual circumscribed circle passing through the three vertices of the triangle of the bearing, and the rounded triangular form of the pivot exhibits a diameter D2 of a virtual circumscribed circle passing through the three vertices of the triangle of the pivot, where the relationship D2′/D2 lies between 0.7 and 0.99.

In one embodiment, a contact surface S, present between the pivot and the bearing when the pivot is inserted into the bearing and is displaced in an angular fashion in order to assure a self-locking effect, extends for a length of between 1/10 and 9/10 of the total length of a side of the rounded polygon of the pivot.

The difference in diameter between D2 and D2′ and the form of the bearing and the pivot permit the insertion of the pivot into the bearing to be self-centering, permitting a self-locking effect by an angular displacement, the extraction of the pivot from the bearing being effected by an angular displacement opposite to the angular displacement for the self-locking.

The characterizing features of the invention will be appreciated more clearly from a perusal of the description of a plurality of embodiments that are given solely by way of example and are in no way restrictive and with reference to the schematic figures, in which:

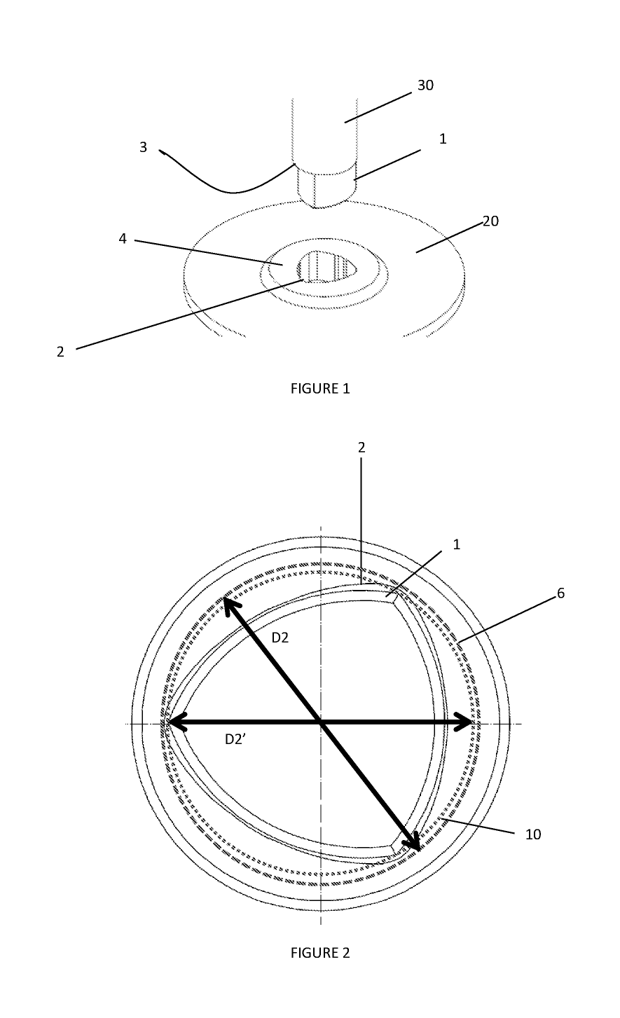

FIG. 1 depicts a view in perspective of a bearing and a pivot, of rounded equilateral triangular form;

FIG. 2 depicts a view from below of a pivot inserted into a bearing, the pivot and the bearing being of rounded equilateral triangular form;

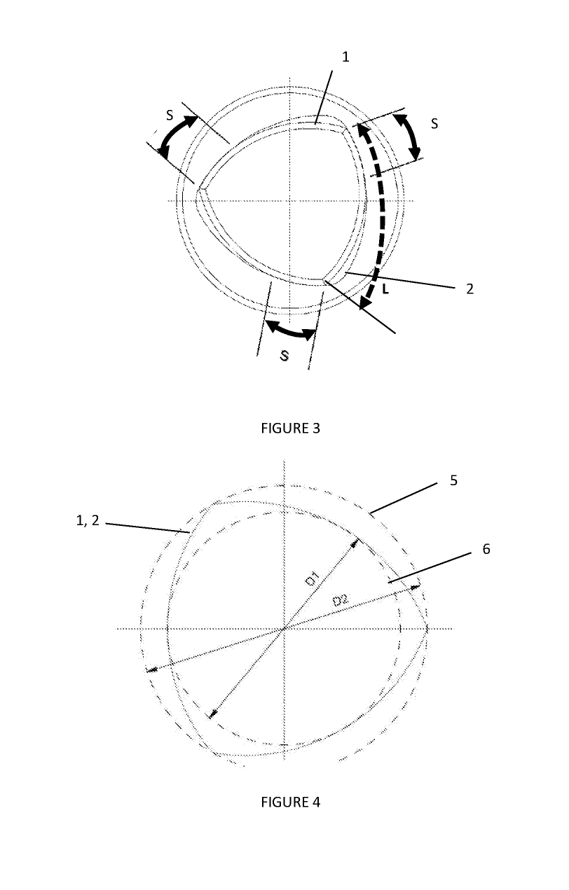

FIG. 3 depicts a view from below of the pivot and the bearing in FIG. 2, the pivot having been displaced in an angular fashion in a clockwise direction;

FIG. 4 depicts a view from below of a pivot or a bearing of rounded equilateral triangular form;

FIG. 5 depicts a view in perspective of a coaxial coupling of two barrels, a pivot and a bearing of rounded equilateral triangular form ensuring the connection between the two barrels; and

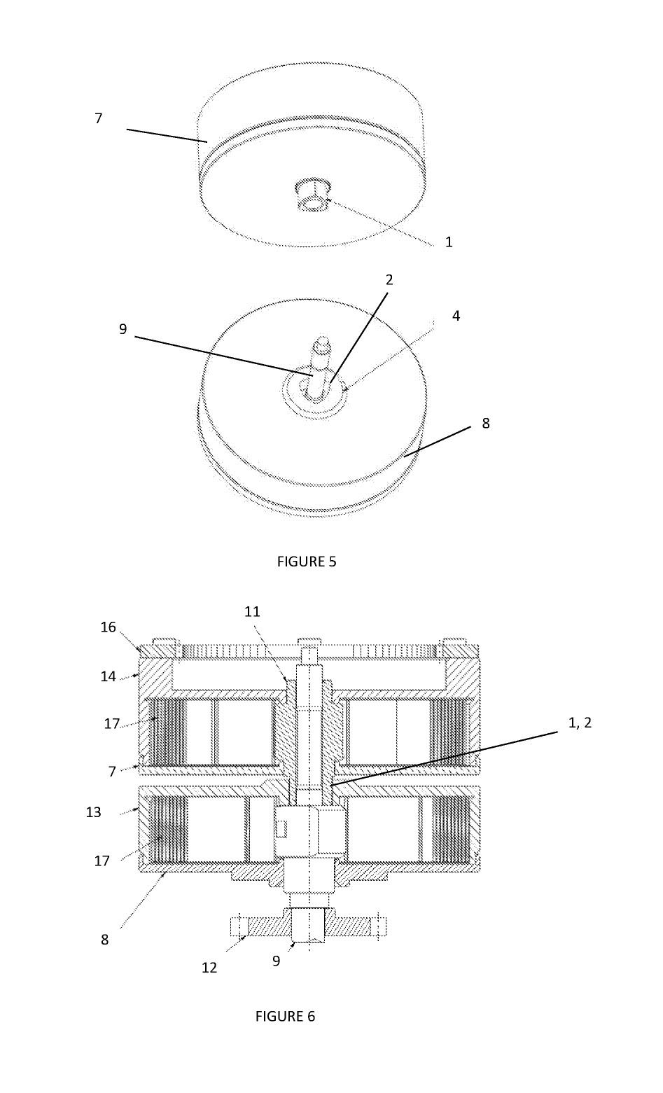

FIG. 6 depicts a sectional view of two barrels coupled coaxially.

As illustrated in FIG. 1, a coaxial coupling of two timepiece components rotating about a common axis is produced from a first timepiece component (partially illustrated) attached to an arbor 30 including a pivot 1 at one of its extremities and a second timepiece component 20 (partially illustrated) including a bearing 2 receiving said pivot 1. The pivot 1 and the bearing 2 have the form of a rounded equilateral triangle, respectively male or female, and are arranged in such a manner that the pivot 1 engages in the bearing 2 with an angular clearance permitting rotation of the arbor 30 to be transmitted to the second component 20 by a self-locking effect. The pivot 1 includes a seat 3 rubbing against a face 4 of the timepiece component 20.

As illustrated in FIG. 2, the pivot 1 is inserted into the bearing 2, the pivot 1 and the bearing 2 being of rounded triangular form. The rounded triangular form of the bearing 2 exhibits a diameter D2 of a virtual circumscribed circle 6 passing through the three vertices of the triangle of the bearing 2, and the rounded triangular form of the pivot 1 exhibits a diameter D2′ of a virtual circumscribed circle 10 passing through the three vertices of the triangle of the pivot (1). In this example, the difference between the diameters D2′ and D2 is small, and the value of the relationship D2′/D2 is 0.93.

This small difference in diameter between D2′ and D2 makes it possible, when the pivot 1 is displaced in an angular fashion once it has been received in the bearing 2, to maximize the contact surfaces, and makes it possible to prevent strain hardening of the material. In the example illustrated in FIG. 3, the pivot 1 is displaced in an angular fashion in the bearing 2 in a clockwise direction. The contact surface S between the pivot 1 and the bearing 2, when the pivot 1 is inserted into the bearing 2 and is displaced in an angular fashion in order to ensure a self-locking effect, extends for a length of about ⅓ of the total length L of a side of the triangle of the pivot 1.

In the example in FIG. 3, the pivot 1 of rounded triangular male form is received in the rounded triangular female form of the bearing 2 and, after angular displacement, the pivot 1 and the bearing 2 are rotationally connected about the same axis. The insertion of the pivot 1 into the bearing 2 is self-centering, permitting a self-locking effect by this angular displacement. The extraction of the pivot 1 from the bearing 2 takes place by an angular displacement opposite to the angular displacement for the self-locking.

As illustrated in FIG. 4, the rounded triangular form of the pivot 1 and the bearing 2 exhibits a diameter D1 of a virtual inscribed circle 6 tangent to the three sides of the triangle and a diameter D2 of a virtual circumscribed circle 5 passing through the three vertices. The relationship D1/D2 is about 0.83 in this example. The difference between the diameters, external D2 and internal D1, is small and makes it possible, for example, to have a rigid axis and to be able to hollow out the center of the arbor. The pivot 1 may thus be hollowed out in such a manner as to be traversed by an arbor of a larger diameter than if the pivot were to have a square form.

FIGS. 5 and 6 depict an arrangement for coupling two barrels 7, 8 in series in a coaxial manner. The two barrels 7, 8 rotate about a common axis mounted in series, namely a first barrel 8 attached to an arbor 9 including said bearing 2 at one of its extremities and a second barrel 7 including said pivot 1 receiving said bearing 2.

FIG. 6 depicts a sectional view of a coaxial coupling of two barrels 7, 8 in series. Each of the barrels 7, 8 includes a barrel drum 13, 14, each acting as a housing for a spring 17 and as a pivot for a barrel arbor permitting the attachment of the springs 17 by a hook situated on a barrel arbor collet. A first arbor 9 of the barrel 8 is driven causing it to rotate by an external wheel 12, the first arbor 9 of the barrel 8 causing a drum 13 of the barrel 8 to turn. The drum 13 of the barrel 8 includes a bearing 2, in which a pivot 1 formed in a second arbor 11 of the barrel 7 is received. The first arbor 9 of the barrel 8 turns freely in the second arbor 11 of the barrel 7.

Thus, when the timepiece is wound, the arbor 9 of the barrel 8 is driven causing it to rotate by the wheel 12. The spring 17 causes the drum 13 of the barrel 8 to turn by means of a hook of the arbor 9 of the barrel 8. The drum 13 of the barrel 8 includes the bearing 2 (FIG. 5) in which a pivot 1 formed in the arbor 11 of the barrel 7 is received. This receiving permits the two barrels 7, 8 to be coupled without additional components. The arbor 11 of the barrel 7 turns freely around the arbor 9 of the barrel 8 and drives the spring 15, which causes the drum 14 of the barrel 7 to turn. A ring gear 16, integral with the drum 14 of the barrel 7, transmits the energy to the timepiece movement.

In the illustrated examples, the preferred geometrical form of the pivot 1 and of the bearing 2 is triangular, although this geometrical form may be polygonal, for example pentagonal, in variants that are not described here.

This coaxial coupling of two timepiece components makes it possible in particular to save space inside a movement, whether this is a wristwatch, a pocket watch or a table clock.

1. A timepiece movement comprising two timepiece components rotating about a common axis, namely a first timepiece component attached to an arbor comprising a pivot (1) at least at one of its extremities and a second timepiece component comprising a bearing (2) receiving said pivot (1), the pivot (1) and the bearing (2) having the form of a rounded regular polygon with three to six sides, preferably a rounded equilateral triangle, respectively male or female, arranged in such a manner that the pivot (1) engages in the bearing (2) with an angular clearance enabling rotation of the arbor to be transmitted to the second component by a self-locking effect,
characterized in that the pivot (1) and the bearing (2) have the form of a rounded equilateral triangle
the rounded triangular form of the pivot (1) and the bearing (2) exhibiting respectively a diameter D1, D1′ of a virtual inscribed circle (6, 10) tangent to the three sides of the triangle and respectively a diameter D2, D2′ of a virtual circumscribed circle (5) passing through the three vertices, where the relationship D1/D2 and D1′/D2′ lies between 0.5 and 0.95.

2. (canceled)

3. (canceled)

4. The movement as claimed in claim 1, in which the rounded triangular form of the bearing (2) exhibits a diameter D2 of a virtual circumscribed circle (6) passing through the three vertices of the triangle of the bearing (2), and the rounded triangular form of the pivot (1) exhibits a diameter D2′ of a virtual circumscribed circle (10) passing through the three vertices of the triangle of the pivot (1), where the relationship D3/D2 lies between 0.7 and 0.99.

5. The movement as claimed in claim 1, in which a contact surface S, established between the pivot (1) and the bearing (2) when the pivot (1) is inserted into the bearing (2) and is displaced in an angular fashion in order to ensure a self-locking effect, extends for a length of between 1/10 and 9/10 of the total length of one side of the rounded polygon of the pivot (1).

6. The movement as claimed in claim 1, in which the insertion of the pivot (1) into the bearing (2) is self-centering, permitting a self-locking effect by an angular displacement, the extraction of the pivot (1) from the bearing (2) being effected by an angular displacement opposite to the angular displacement for the self-locking.

7. The movement as claimed in claim 1, in which the pivot (1) includes a seat (3) rubbing against a face (4) of a timepiece component including the bearing (2).

8. The movement as claimed in claim 1,
in which the pivot (1) is hollowed out.

9. The movement as claimed in claim 1, comprising two barrels (7, 8) rotating about a common axis mounted in series, namely a first barrel (8) secured to an arbor (9) including said bearing (2) at least at one of its extremities and a second barrel (7) including said pivot (1) receiving said bearing (2).

10. The movement as claimed in claim 9, in which a first arbor (9) of the first barrel (8) is driven causing it to rotate by a wheel (12), the first arbor (9) of the first barrel (8) causing a drum (13) of the first barrel (8) to turn, the drum (13) of the first barrel (8) including a bearing (2) in which a pivot (1) formed in a second arbor (11) of the second barrel (7) is received, the first arbor (9) of the first barrel (8) turning freely in relation to the second arbor (11) of the second barrel (7).

11. A timepiece, characterized in that the timepiece comprises a movement as claimed in claim 1.

12. The timepiece as claimed in claim 11 in the form of a wristwatch or a pocket watch or a table clock.
